(19) United States
(12) Patent Application Publication
(10) Pub. No.: US 2006/0209640 A1
(43) Pub. Date: Sep. 21, 2006

(54) Method for dividing user storage space of an optical disc, optical disc having divided storage space, and method and device for storing information

(75) Inventors: Johannes Friso Rendert Blacquiere, Eindhoven (NL); Gerrit Jan Scholl, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/539,391

(22) PCT Filed: Dec. 3, 2003
(86) PCT No.: PCT/IB03/05722

§ 371 Date: Jun. 15, 2005

(30) Foreign Application Priority Data
Dec. 20, 2002 (EP) 02080530.5

(51) Int. Cl. G11B 21/08

(52) U.S. Cl. 369/30.01

(57) ABSTRACT

A method is described for writing an optical disc (2) having a user storage space (USS). The method comprising the steps of dividing the storage space of an optical disc (2) into, on the one hand, one or more sections (80; 181, 182, 183, 184) where an application is allowed to write and, on the other hand, one or more sections where it is not allowed to do so. The location and extent of the allowed section(s) is either fixed in format or determined by one or more parameters (BA, L, VAPT) stored on disc. A signal processing system (120) of a video recorder apparatus (100) is designed, before attempting a write operation to a disc (2), to determine the allowed storage area (VASS) for the present disc, and to select free area (72) for writing only within the allowed storage area.

### FIELD OF THE INVENTION

The present invention relates in general to a method and device for storing information on a recordable storage medium. More particular, the present invention relates to a method and device for storing information on a recordable optical disc. Specifically, the present invention relates to storing information on a user-recordable Digital Versatile Disc (such as DVD+RW or DVD-RW), and the invention will hereinafter be explained specifically for this example; however, it is to be understood that the present invention is not restricted to DVDs, and that its teaching is applicable in other fields.

### BACKGROUND OF THE INVENTION

Optical discs in general are known. As is commonly known, an optical disc has a storage space which physically has the shape of a track, either in the shape of a plurality of concentric circular tracks or one (or more) continuous spiral shaped track. Data can be written on the track by means of an optical beam, such optical beam changing certain properties of the disc. Writing occurs at a specific storage location, which has a specific logical address and a specific physical position.

Since the technology of storing information on optical discs in general is known per se, a more detailed description of this technology is omitted here. Similarly, since the technology of storing information on DVDs is known per se, a more detailed description of this technology is omitted here.

The information to be written can be of different types. For instance, it is possible that the information consists of a video recording, but it is also possible that the information consists of computer data. Other types of information are feasible, too. Typically, the writing operation is performed by a user application according to predefined protocols or formats, as will be known to a person skilled in the art. Typically, for different types of information, the corresponding formats are different. For instance, the format for video differs from the format for computer data. This difference does not only come to expression in the data coding formulas, but also in the way how the data is organized on disc. For instance, the video format requires that a recording is substantially contiguous, whereas computer data may in principle be scattered over the entire disc, organized in files, while a file managing system keeps a table of information relating to the storage locations of the files, which table is stored on disc.

The user applications may be designed to operate according to one format only. For instance, a video recorder apparatus is designed, in principle, to write video according to video format only. Conventional computers are designed to write computer data according to data format only.

More recent apparatus are capable to handle both types of formats. For instance, a modem DVD video recorder apparatus is designed to put the recordings and additional information in a set of files, so that the recordings become visible in a PC. Conversely, modem personal computers comprise a video application, allowing a user to view or record video.

A problem is that different recording formats have different requirements regarding the allocation of information on disc. A further problem is that different recording formats do not respect each others requirements. The most important source of these problems is that the individual formats have been developed on the basis of the assumption that a specific disc would be used for one purpose only, i.e. video only or PC data only. Indeed, if a user would restrict the use of a disc to either video or PC data, he would encounter no problems. However, it is desirable to allow one disc for recording video as well as PC data.

For instance, assume that a disc contains computer data. If, later, it is desired that a video recording is stored on this disc, it may be that the video recording application does not recognize or at least does not respect the computer data, in which case the video recording application may simply overwrite said computer data.

In order to avoid this problem, prior art proposes to subdivide the storage space of the disc in two or more partitions, each partition being intended for storing a specific information type, for instance a video partition and a computer data partition. One disadvantage of this approach is that partitioning needs to be done on formatting of the disc, before data is written for the first time. It is, in fact, possible to change the partitioning later, but this is difficult and requires much work and therefore much time, particularly with a view to maintaining all existing data on disc: these need to be shifted to another location, or all address information needs to be updated.

Another disadvantage is that, for each type of information, the size of the storage space is limited to the size of the corresponding partition; for instance, it is not possible to write video in the computer data partition.

The present invention aims to provide a solution to these problems which does not suffer from such disadvantages.

### SUMMARY OF THE INVENTION

According to an important aspect of the invention, a storage region available to an application is limited by defining one or more availability parameters.

This may be implemented as one predefined location (address), defined in the application format, this location acting as a boundary effectively dividing the storage space in two regions, i.e. one region with addresses below said boundary and a second region with addresses above said boundary. Further, an application will be designed to restrict writing to one of these regions only, leaving the other region to other applications.

Thus, effectively, the video application is prevented from writing in said second region, and the integrity of computer data written in said second region is preserved.

### BRIEF DESCRIPTION OF THE DRAWINGS

These and other aspects, features and advantages of the present invention will be further explained by the following description of preferred embodiments of the method according to the present invention with reference to the drawings, in which same reference numerals indicate same or similar parts, and in which:

FIG. 1 is a functional block diagram, schematically illustrating a disc drive;

FIGS. 2-5 schematically illustrate storage space of a disc.

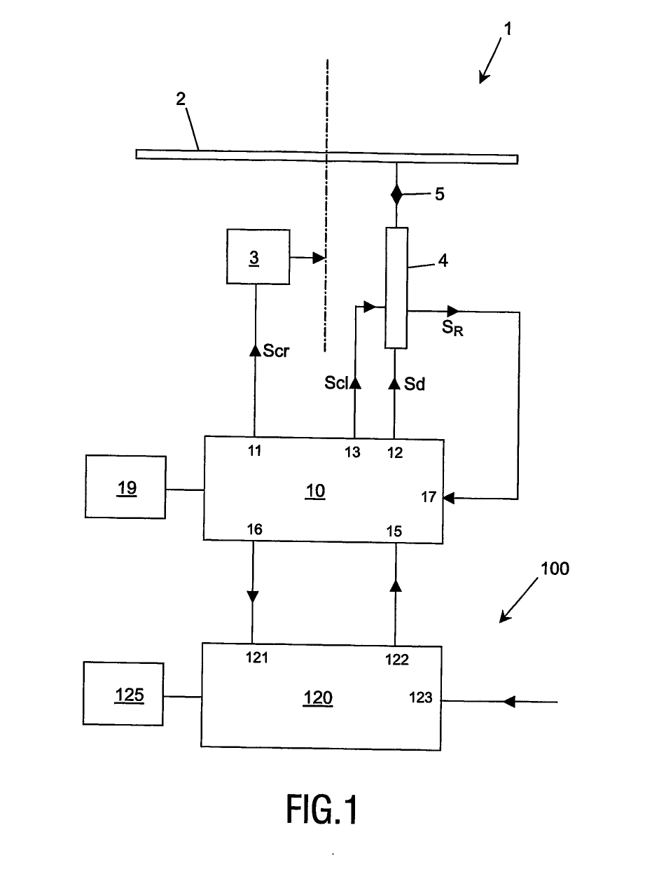

FIG. 1 schematically shows relevant components of a DVD disc drive apparatus, generally indicated with reference numeral 1. The disc drive 1 comprises receiving means (not shown for sake of convenience) for receiving a DVD 2, and rotating means 3, typically including a motor, for rotating the DVD 2 at a predetermined rotational speed. Since such receiving means and rotating means are well known in prior art, it is not necessary here to explain their design and functioning in detail.

As is commonly known, a DVD 2 comprises tracks for writing data, and written data can be read from the tracks. The tracks may be implemented as a plurality of separate, circular tracks, mutually concentric, but the tracks may also be implemented as consecutive turns of a unique, continuous spiral-shaped track. For the context of the present invention, the type of track is not important.

For reading and writing data by optical means, the disc drive 1 further comprises an optical system 4 which comprises light beam generating means arranged for scanning the surface of the rotating disc 2 with an optical beam 5, and which comprises an optical detector for receiving a beam reflected from the disc and for deriving a read signal SR from the reflected beam. Typically, the light beam is a laser beam, generated by a laser diode. Since in general such optical system is well known in prior art, it is not necessary here to explain its design and functioning in detail.

The disc drive 1 further comprises a disc drive system 10, designed to control the rotating means 3 and the optical system 4 for performing a write operation at a certain location. In FIG. 1, the disc drive system 10 is illustrated as having an input 17 for receiving the read signal SR. Further, the disc drive system 10 is illustrated as having a first output 11 providing a first control signal Scr controlling the operation of the rotating means 3. Further, the disc drive system 10 is illustrated as having a second output 12 providing a data signal Sd to the optical system 4. The disc drive system 10 is further illustrated as having a third output 13 for providing a second control signal Sc1 for the optical system 4. The data signal Sd represents the information to be written into the optical disc 2. As will be clear to a person skilled in the art, the disc drive system 10 determines at what disc location to write the data by generating a suitable combination of the control signals Scr and Sc1. Since such disc drive system 10 is known per se, it is not necessary here to explain its design and functioning in detail.

The disc drive 1 is incorporated in a host system 100, capable of writing video recordings on disc. In the present example, it will be assumed that the host system 100 is a video recorder apparatus. However, it should be clear that the following explanation is also applicable to any other type of video recording application, such as for instance a personal computer having a video recording facility, i.e. a video recording program running on a personal computer.

The video recorder apparatus 100 comprises a signal processing system 120 having an input 121 coupled to an output 16 of the disc drive system 10, and having an output 122 coupled to an input 15 of the disc drive system 10. The signal processing system 120 further has a video data input 123 for receiving video data to be stored from any suitable source, for instance a video tuner (not shown) coupled to a cable distribution system (not shown) or an antenna (not shown). The signal processing system 120 is designed for handling the writing of video recordings to disc, i.e. to suitably encode incoming video data according to a predefined video writing format, such as for instance the DVD+RW video format specification (also indicated as DVD+VR), and to generate suitable instructions for the disc drive 1 in order to write the encoded video data at a disc location determined by the signal processing system 120, as will be clear to a person skilled in the art.

The video recorder apparatus 100 further comprises a memory 125 associated with the signal processing system 120.

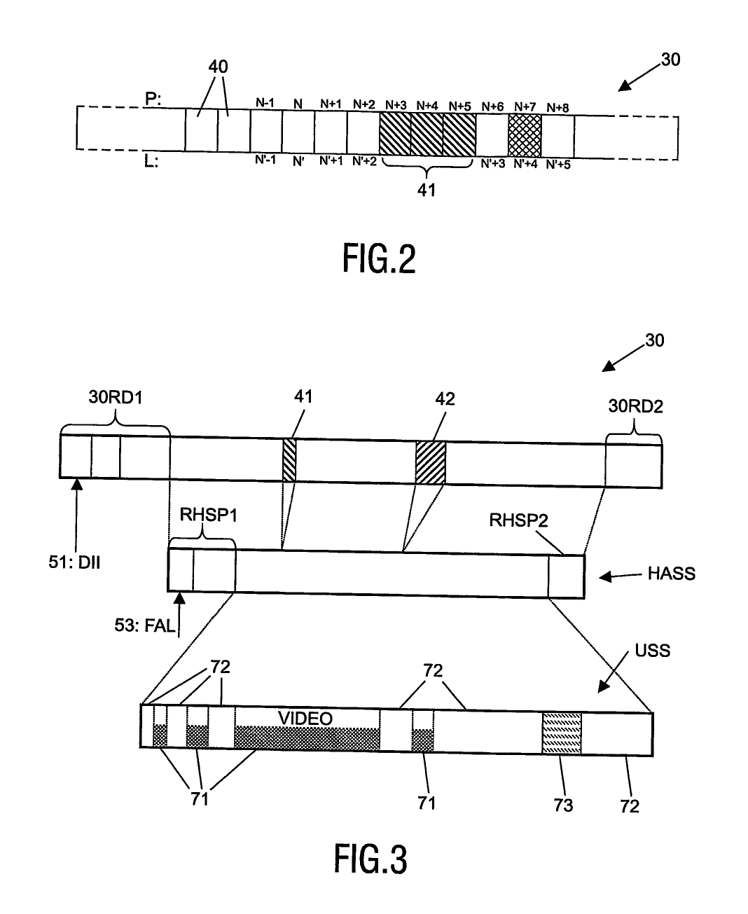

FIG. 2 is a diagram schematically illustrating a storage space 30 of the DVD 2 as a continuous ribbon, divided into storage blocks 40. Each storage block can contain a predetermined number of data bits, as will be known to a person skilled in the art. Each storage block 40 has a unique physical disc address, which substantially corresponds to the physical position of such block on the disc. In FIG. 2, the physical disc addresses P of the blocks 40 are indicated as consecutive numbers, each block 40 having a physical disc address corresponding to the physical disc address of its predecessor plus one.

As illustrated in FIG. 2, the logical blocks 40 also have a logical disc address L, allocated by the drive system 10. Logical addresses may differ from physical disc addresses. An important difference is that not all usable blocks are given a logical disc address. For instance, the drive system 10 may have defined spare areas for defect management, such as described in the Mount Rainier standard. Such spare areas are not available for normal storage of user data, i.e. they are not visible to a user and they do not have obtained logical addresses. In the example of FIG. 2, a spare area 41 contains blocks having physical disc addresses N+3, N+4 and N+5.

As another example, in DVD, the drive system 10 reserves the first 30000[HEX] blocks for lead in, so that logical disc address L=1 corresponds to physical disc address P=30001.

FIG. 3, similar to FIG. 2, also shows the storage space 30 as a ribbon, but now on a different scale. While FIG. 2 illustrates individual blocks of a very small portion of the storage space 30, FIG. 3 shows the entire storage space 30.

In the example illustrated in FIG. 3, two portions 30RD1 and 30RD2, also indicated as lead-in area and lead-out area, respectively, which are made during formatting of the disc, are reserved for use by the disc drive system 10 itself, i.e. these portions of the storage space 30 are not available for storing user data. The drive system 10 has allocated logical disc addresses to the remaining part of the storage space 30, with the exception of spare areas 41 and 42. The drive system 10 uses the logical disc addresses to make this part of the storage space 30, indicated hereinafter as host available storage space HASS, available to the signal processing system 120 of the video recorder apparatus 100.

The mapping of physical disc addresses to logical disc addresses is usually done in accordance with a predefined standard, for instance the DVD+RW standard or the DVD+MRW standard (Mount Rainier standard). A certain first portion 51 of the reserved storage space 30RD1 contains information identifying the format of the disc, so that the relation between physical disc addresses and logical disc addresses can be derived by the disc drive system 10. This information will be indicated as disc identification information DII.

The signal processing system 120 performs a remapping of the logical disc addresses as defined by the disc drive, so as to define a logical space to a user, indicated hereinafter as user storage space USS, available for storing user video data. Herein, the signal processing system 120 reserves parts of the host available storage space HASS for its own use, which reserved parts will hereinafter be indicated as reserved host storage portions RHSP1 and RHSP2; the remaining part of host available storage space HASS is made available for a user as user storage space USS; logical addresses in this user storage space USS are indicated as logical user addresses.

When a DVD is placed into a disc drive, the disc identification information DII in the said portion 51 of the reserved storage space 30RD1 is copied into a memory 19 associated with the drive system 10, so that the drive system 10 knows which physical disc addresses P correspond to logical disc addresses L.

When storing information into the disc, the signal processing system 120 determines logical user addresses for the data to be stored, and translates these logical user addresses into logical disc addresses L, which are translated into physical disc addresses P by the disc system 10, taking into account the disc identification information DII in said portion 51 of the reserved storage space 30RD1.

FIG. 3 illustrates a user storage space USS which contains one or more video recordings and one or more computer data files. The hatched area 71 represents storage space which actually contains video data written therein, while the hatched area 73 represents storage space which actually contains computer data written therein; the remaining area 72 is empty, i.e. it has never been written yet, or its contents has been deleted and area 72 is now available for new recordings.

The signal processing system 120 keeps record of the video recordings written o disc. This information, which will hereinafter be indicated as video recording location information VRLI, and which involves inter alia the logical user addresses of the recordings, is stored in said memory 125, and is also written in one of the areas 71 on disc in accordance with the predefined DVD format; in FIG. 3, this video recording location information VRLI is illustrated as being written in the leftmost area 71. Thus, other video applications are able to read said information.

The VRLI defines the location and extent of the recorded areas 71 in general, more specifically the start addresses of individual video recordings. The VRLI is used for locating a specific recording if it is desired to play this recording. The VRLI is also used by a video application which is about to write a new recording. The signal processing system 120 will determine a start address for the new recording, which may be next to the end of the last recording or, if the user wishes to record over an already existing recording, the beginning of such existing recording. If the new recording overwrites any of the additional video files, for instance the rightmost area 71 in FIG. 3, the information in this file is written again, updated if necessary, beyond the end of the new recording, so that the structure illustrated in FIG. 3 is maintained, albeit that the size of one or more of the areas 71 has increased while also the location of one or more of the areas 71 may have changed.

By using the VRLI in this way, video applications respect already existing recordings.

Computers have a different format for writing data. Computer data is written in the form of files, and a list of the files stored by the user is stored in a portion 53 of the reserved host storage portion RHSP1 (as illustrated in FIG. 3), or in file system descriptors stored in the user storage space USS. This list, which includes the logical disc addresses corresponding to the files stored by the user, is indicated as file allocation list FAL. When writing new data, a file system of a computer will consult the file allocation list FAL in order to find free storage space.

However, conventional video applications are not designed to consult the file allocation list FAL, and are not even capable of recognizing that the disc contains computer data. For such conventional video applications, it is only the video recording location information VRLI which is consulted. Thus, when looking for a contiguous free area 72, a conventional signal processing system 120 will not respect the computer data containing area 73, and will simply overwrite the computer data stored therein.

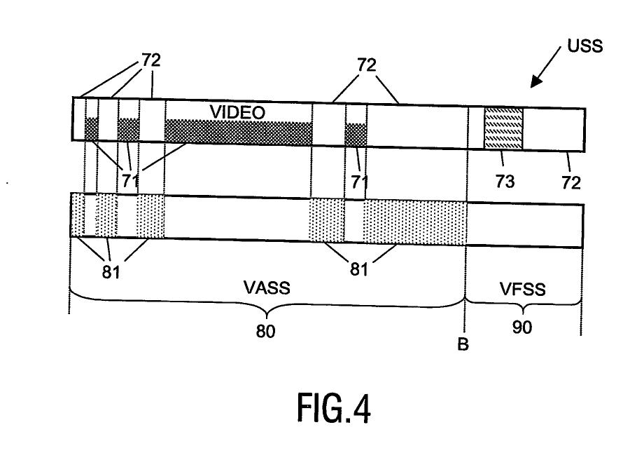

In order to prevent this problem, the present invention proposes to define at least one borderline between at least one first contiguous part of the user storage section USS where video applications are allowed to write recordings, and at least one second contiguous part of the user storage section USS where it is effectively forbidden for video applications to write recordings. FIG. 4 illustrates an example of such division. Said first part of the user storage section USS will be indicated as video-allowed storage section VASS 80, while said second part of the user storage section USS will be indicated as video-forbidden storage section VFSS 90. The borderline B between these two storage areas is defined by a certain storage address.

As prescribed in the video format, this video-allowed storage section VASS 80 extends from the start of the user storage space USS.

According to the invention, the signal processing system 120 of the video recorder apparatus 100 is designed, when selecting free area 72 for writing a recording, to disregard addresses beyond said borderline B and to only select free area below said borderline, this free area being indicated at 81. Thus, any data stored in video-forbidden storage section VFSS 90 beyond said borderline B is effectively safeguarded from being overwritten.

The location of the borderline B, indicated as borderline address BA, may be fixed in the video format. In that case, the borderline address will be the same for different discs.

Preferably, however, the borderline address BA is defined as a variable parameter whose value is stored in a predetermined area or location of storage space 30. In that case, a signal processing system 120 of the video recorder apparatus 100 according to the invention is designed, when selecting free area 72 for writing a recording, to read the borderline address BA from disc, and to only select free area below the borderline address BA thus obtained.

Effectively, the borderline address BA results in a soft-partitioning of the user storage space USS into one portion 80 available for video use and a second portion 90 available to other applications only, i.e. not available for video use. It may be that, in practice, it appears that a user wishes to make a further video recording of a length larger than the capacity of video-allowed storage section VASS allows, while video-forbidden storage section VFSS 90 has storage space available adjacent to the video-allowed storage section VASS 80. Preferably, the signal processing system 120 of the video recorder apparatus 100 is capable to redefine the borderline address BA such that the end of video-allowed storage section VASS is shifted towards the end of the user storage space USS, and to also write the amended value of the borderline address BA to disc, effectively increasing the video-allowed storage section VASS 80 and decreasing the video-forbidden storage section VFSS 90.

On the other hand, it may also be that, in practice, it appears that a user wishes to store computer data of an amount more than the capacity of the free part of the video-forbidden storage section VFSS 90, while the free part of the video-allowed storage section VASS 80 has storage space available at its end, i.e. adjacent to the video-forbidden storage section VFSS 90. Preferably, the signal processing system 120 of the video recorder apparatus 100 is capable to redefine, on command of a user, the borderline address BA such that the end of video-allowed storage section VASS is shifted away from the end of the user storage space USS, and to also write the amended value of the borderline address BA to disc, effectively decreasing the video-allowed storage section VASS 80 and increasing the video-forbidden storage section VFSS 90.

In such cases, different discs may have different borderline addresses.

In the above example, the borderline address BA is discussed as a parameter belonging to the format of a certain application (i.e. video application), the format restricting the application to only write to the storage section area with addresses below said borderline address BA. In that case, the entire section of user storage space extending from the inner side of the disc to said borderline address BA is available to said application. Alternatively, it is possible that the borderline address BA is a lower margin belonging to the format of a certain application, the format restricting the application to only write to the storage section area with addresses above said borderline address BA. In that case, the entire section of user storage space extending from said borderline address BA to the outer side of the disc is available to said application.

In the above examples, the video-allowed storage section VASS is effectively defined by two addresses, i.e. a start address fixed in the video format and an end address BA either fixed in the video format or a variable parameter, its value being stored on disc. Alternatively, it is possible that the video-allowed storage section VASS is effectively defined by one address and a section length SL. The said one address may be the start address fixed in the video format. The said length SL may also be a fixed value fixed in the video format, or it may be a variable parameter, its value being stored on disc.

In the above examples, the video-allowed storage section VASS is shown as one contiguous part (extent) of the user storage space USS. However, it may be that it is advantageous for an application (video application) to reserve storage space which is fragmented. For instance, it may be desirable to have storage space reserved close to spare storage spaces in order to assure that, in the case of a possible defective storage location, the distance between such defective location and spare storage space is always relatively small. As another example, for safety reasons it may be desirable to be able to store a certain file at different locations at relatively large distances from each other, so that, in the case of a damaged disc, the changes on recovery of the data of this file are increased. In such case, it is advantageous if the video application would treat these reserved storage spaces as forbidden storage sections. This can be achieved by defining multiple video-allowed storage sections VASS alternating with video-forbidden storage sections VFSS.

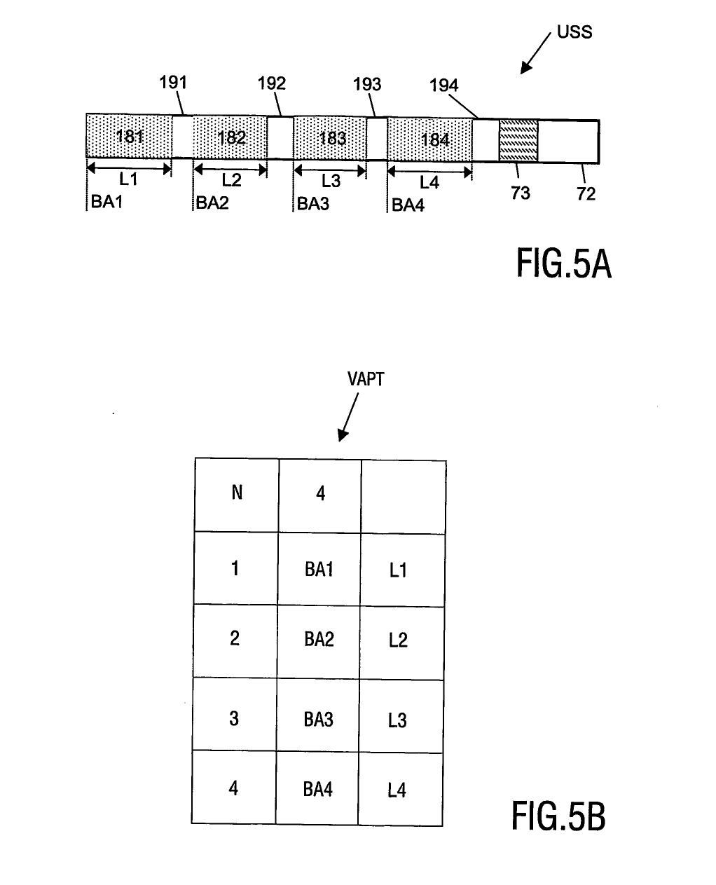

FIG. 5A is a figure comparable to FIG. 4, illustrating a user storage section USS which, instead of only one contiguous video-allowed storage section VASS 80, contains multiple (here: four) video-allowed storage sections VASS 181, 182, 183, 184, followed by corresponding video-forbidden storage sections 191, 192, 193, 194, respectively.

Figure SA also illustrates that it is possible to define the set of multiple video-allowed storage sections VASS by two parameters each, a start location BA1, BA2, BA3, BA4, respectively, and a length L1, L2, L3, L4, respectively. Instead of defining start locations, it is possible to define end locations. Instead of defining start/end location and length, it is possible to define start location and end location. It is noted that the lengths of the video-allowed storage sections VASS do not necessarily need to be equal.

The number of video-allowed storage sections VASS present, and the set of parameters defining the set of multiple video-allowed storage sections VASS, may have predetermined values, fixed in the format. However, more flexibility is achieved if the set of parameters have variable values stored on disc. FIG. 5B shows an example of a video-allowed parameter table VAPT which can be stored at a predetermined location in the storage space 30 of disc 2. Such table can have a fixed length, i.e. contain a fixed number of records relating to a fixed number of video-allowed storage sections VASS. However, most flexibility is achieved if the table also contains at least one entry defining the length of the table: as shown in the example of FIG. 5B, the first line of the table VAPT contains a variable number N indicating the number of video-allowed storage sections VASS, whose value is 4 in this example.

A signal processing system 120 of the video recorder apparatus 100 in accordance with the present invention is designed, when selecting free area 72 for writing a video recording, to read the video-allowed parameter table VAPT from disc and to only elect free area 72 in one or more of the video-allowed storage sections VASS as defined by he video-allowed parameter table VAPT.

Thus, in accordance with the present invention, the storage space of an optical disc 2 is divided into one or more sections where a video application is allowed to write and one or more sections where it is not allowed to do so. The location and extent of the allowed section(s) is either fixed in the format or determined by one or more parameters BA, L, VAPT stored on disc. The signal processing system 120 of a video recorder apparatus 100 is designed, before attempting a write operation to a disc 2, to determine the allowed storage area VASS for the present disc, and to select free area 72 for writing only within the allowed storage area.

It should be clear to a person skilled in the art that the present invention is not limited to the exemplary embodiments discussed above, but that various variations and modifications are possible within the protective scope of the invention as defined in the appending claims.

For instance, it is noted that in the above the invention is explained for a case of two applications, i.e. a video recording application and a computer data writing application. However, the present invention is not restricted to such case. It is possible that any other type of application is designed to limit its freedom to select free area on a disc in the manner proposed by the present invention. Further, it is very well possible that a second application is designed to limit its freedom to select free area on a disc in the manner proposed by the present invention, by defining one or more second application-allowed storage sections within one or more of first application-forbidden storage sections left free by an earlier application.

Further, in the above, the invention is explained illustratively by discussing parameters (B;L) which define start address and extent of video-allowed storage sections. However, the present invention can also be executed by using parameters which define start address and extent of video-forbidden storage sections. Since this, actually, is equivalent to using parameters which define start address and extent of video-allowed storage sections, the expression “parameter which defines location and/or extent of allowed storage sections” as used in the claims is intended to also cover an implementation using parameters which define start address and extent of video-forbidden storage sections.

Further, in the above, the invention is explained for a disc having a video storage section extending from the beginning of storage space and having a data storage section extending till the end of storage space. However, it is also possible to have first a data storage section extending the beginning of storage space to a certain border line, then a video storage section extending from this border line to a second border line, and then a data storage section extending till the end of storage space. Multiple segments are also possible.

1. Method for dividing user storage space of an optical disc into one or more storage sections where a specific application is allowed to write and one or more sections where said application is not allowed to write;
the method comprising the steps of:
defining one or more availability parameter(s) which define(s) location and/or extent of at least one application-allowed storage section.

2. Method according to claim 1, wherein at least some of said one or more availability parameter(s) is(are) incorporated in a standard format for the application concerned.

3. Method according to claim 1, wherein at least some of said one or more availability parameter(s) is(are) variable parameters whose value(s) is(are) stored in a predetermined area or location of storage space of the disc.

4. Method according to claim 1, wherein at least one of said availability parameter(s) defines a borderline address between an application-allowed storage section and an application-forbidden storage section.

5. Method according to claim 1, wherein at least one of said availability parameter(s) defines an extremity address of an application-allowed storage section.

6. Method according to &claim 1, wherein at least one of said availability parameter(s) defines a length of an application-allowed storage section.

7. User-writeable optical disc having user storage space divided into one or more storage sections where a specific application is allowed to write and one or more sections where said application is not allowed to write;
the optical disc comprising a predetermined area or location of storage space where one or more availability parameter(s) is(are) stored which define(s) location and/or extent of at least one application-allowed storage section.

8. User-writeable optical disc according to claim 7, wherein at least one of said availability parameter(s) defines a borderline address between an application-allowed storage section and an application-forbidden storage section.

9. User-writeable optical disc according to claim 7, wherein at least one of said availability parameter(s) defines an extremity address of an application-allowed storage section.

10. User-writeable optical disc according to claim 7, wherein at least one of said availability parameter(s) defines a length of an application-allowed storage section.

11. User-writeable optical disc according to claim 7, wherein the values of said parameters are stored as a table in a predetermined area or location of storage space of the disc.

12. User-writeable optical disc according to claim 11, wherein said table contains at least one entry defining the length of the table.

13. Method of writing information to an optical disc comprising the steps of:
determining the value of the availability parameter(s);
determining at least one predefined application-allowed storage section on the basis of said availability parameter(s);
consulting application-specific recording location information regarding location and extent of recorded areas;
selecting, within said application-allowed storage section, free area suitable for accommodating the information to be written, taking into account said recorded areas as determined by said application-specific recording location information;
writing said information within said free area thus selected.

14. Method of writing information to an optical disc according to claim 7, comprising the steps of:
reading the availability parameter(s) from disc;
determining at least one predefined application-allowed storage section on the basis of said availability parameter(s);
consulting application-specific recording location information regarding location and extent of recorded areas;
selecting, within said application-allowed storage section, free area suitable for accommodating the information to be written, taking into account said recorded areas as determined by said application-specific recording location information;
writing said information within said free area thus selected.

15. Method according to claim 13, wherein writing to an address outside said application-allowed storage section is avoided.

16. Method according to claim 14, wherein, if it appears that the size of the free area is insufficient to accommodate the information to be written, the following steps are taken:
determining whether the application-forbidden storage section outside said application-allowed storage section, either by itself or in combination with the free area already found, contains a storage space portion suitable and sufficient for accommodating the information to be written;
amending at least one of said availability parameter(s) such as to increase the size of said application-allowed storage section.

17. Apparatus, comprising a signal processing system capable of communicating with a disc drive system of a disc drive apparatus, the signal processing system being designed for executing a method according to claim 1.
